(19) United States
(12) Patent Application Publication
(10) Pub. No.: US 2009/0126360 A1
(43) Pub. Date: May 21, 2009

(54) HYDRAULIC SYSTEM WITH ACCUMULATOR ASSIST

(76) Inventors: Mark A. Bordwell, Olive Branch, MS (US); James E. Bohn, Olive Branch, MS (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/274,686

(22) Filed: Nov. 20, 2008

Related U.S. Application Data
(60) Provisional application No. 60/989,235, filed on Nov. 20, 2007.

(51) Int. Cl. F15B 1/027

(52) U.S. Cl. 60/413

(57) ABSTRACT

A system for operating a hydraulically actuated device that is provided on a vehicle includes a pump drive unit that is adapted to operate a hydraulic pump. The vehicle includes a drive train having a portion that engages the pump drive unit for operation. The system also includes an accumulator and a hydraulically actuated device. Lastly, the system includes a controller that causes the hydraulic pump to supply pressurized fluid to the hydraulically actuated device when a demand is requested by the user. The controller causes the hydraulic system to supply pressurized fluid to the hydraulically actuated device independent of whether the vehicle is moving or stationary.

### CROSS-REFERENCE TO RELATED APPLICATIONS

This application claims the benefit of U.S. Provisional Application No. 60/989,235, filed Nov. 20, 2007, the disclosure of which is incorporated herein by reference.

### BACKGROUND OF THE INVENTION

This invention relates in general to systems for operating hydraulically actuated devices. In particular, this invention relates to an improved system for operating a hydraulically actuated device that is provided on a movable vehicle.

Trucks and other types of movable vehicles are often equipped with one or more hydraulically actuated devices for performing a variety of functions, such as snow plowing, operator lifting, and the like. In vehicles that are so equipped, a source of pressurized fluid is typically provided on the vehicle to operate the hydraulically actuated device in a desired manner. The engine of the vehicle allows the vehicle to be moved as desired, while the source of pressurized fluid allows the hydraulically actuated device to be operated to perform the desired function. Ideally, the source of pressurized fluid allows the hydraulically actuated device to be operated independently of whether the vehicle is moving.

Known sources of pressurized fluid for vehicular-mounted, hydraulically-actuated devices have typically been provided having one of three general types of structures. In the first type of structure, the source of pressurized fluid is an electrically-operated hydraulic pump that is electrically connected to the electrical system of the vehicle. In the second type of structure, the source of pressurized fluid is a mechanically-operated clutch pump that is connected to the engine of the vehicle by means of a belt or other mechanism. In the third type of structure, the source of pressurized fluid is a mechanically-operated hydraulic pump that is driven by a power take-off unit connected to the transmission of the vehicle. Regardless of its specific structure, the source of pressurized fluid is usually capable of supplying a sufficient amount of pressurized fluid to the hydraulically-operated device.

In many cases, however, a primary source of power, such as, for example, an internal combustion engine, is operated to either directly drive the hydraulic system or maintain an electrical charge level for operating an electric pump motor. In order to reduce costs and improve operating efficiency, it may be desirable to hydraulically operate a device with intermittent use of the primary power source.

Also to reduce costs and improve efficiency, hydraulic pumping systems may be sized to accommodate the hydraulically actuated device having the largest single fluid flow requirement. Additionally, however, it may be desirable to operate a second hydraulically actuated device in conjunction with the first device. This may create a situation where a plurality of devices are attempted to be operated with a single pump unit that may not have sufficient output capacity to meet the entire fluid demand. For example, during snow plowing operations, it would be advantageous to operate a device to convey and spread road salt or sand. These salt spreading devices are often hydraulic motor driven devices, such as augers and spreaders. These hydraulic motors typically utilize higher fluid flow rates than an intermittently operated device, such as the hydraulic cylinders of a plow blade structure. During peak demand, the output of the hydraulic system may be momentarily unable to operate both systems adequately. Thus, it would be desirable to also provide an improved system for operating hydraulically actuated devices that are provided on a vehicle having limited pump capacity.

### SUMMARY OF THE INVENTION

This invention relates to an improved system for operating a hydraulically actuated device that is provided on a vehicle. The system includes a pump drive unit that is adapted to operate a hydraulic pump. The vehicle includes a drive train having a portion that engages the pump drive unit for operation. The system also includes an accumulator and a hydraulically actuated device. Lastly, the system includes a controller that causes the hydraulic pump to supply pressurized fluid to the hydraulically actuated device when a demand is requested by the user. The controller causes the hydraulic system to supply pressurized fluid to the hydraulically actuated device independent of whether the vehicle is moving or stationary.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic block diagram of a vehicular drive train assembly and a hydraulic system in accordance with this invention.

FIG. 2 is a more detailed block diagram of the hydraulic system illustrated in FIG. 1.

FIG. 3A is a schematic block diagram of a first embodiment of a pump drive unit of the hydraulic system of FIG. 1.

FIG. 3B is a schematic block diagram of a second embodiment of a pump drive unit of the hydraulic system of FIG. 1.

FIG. 3C is a schematic block diagram of a third embodiment of a pump drive unit of the hydraulic system of FIG. 1.

FIG. 4 is a flowchart that shows the operation of the hydraulic system illustrated in FIGS. 1 and 2 with one or more hydraulically driven devices.

FIG. 5 is a flowchart that shows the operation of the hydraulic system illustrated in FIGS. 1 and 2 with an accumulator as a primary fluid source.

### DETAILED DESCRIPTION OF THE PREFERRED EMBODIMENTS

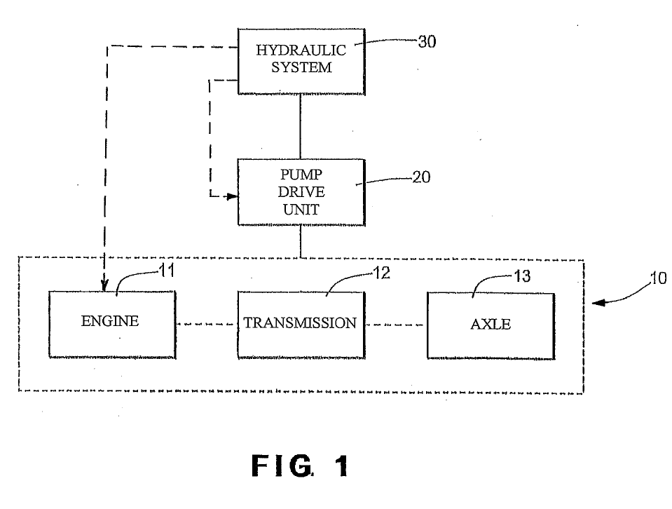

Referring now to the drawings, there is illustrated in FIG. 1 a schematic block diagram of a drive train assembly, indicated generally at 10, for a truck or any other type of vehicle. The illustrated vehicle drive train assembly 10 is, in large measure, conventional in the art and is intended merely to illustrate one environment in which this invention may be used. Thus, the scope of this invention is not intended to be limited for use with the specific structure for the vehicle drive train assembly 10 illustrated in FIG. 1 or with vehicle drive train assemblies in general. On the contrary, as will become apparent below, this invention may be used in any desired environment for the purposes described below.

The illustrated vehicular drive train assembly 10 includes an engine 11, a transmission 12, and an axle assembly 13. The engine 11 is conventional in the art and may be embodied as any source of mechanical rotational power such as, for example, an internal combustion engine or an electric motor. The transmission 12 is also conventional in the art and may, for example, be embodied as an automatic, automated manual, or manual transmission. However, the transmission 12 may be embodied as any desired structure that functions to transfer the mechanical rotational power from the engine 11 to the axle assembly 13 at a variety of moving gear ratios (i.e., forward and reverse), thereby allowing changes of torque and speed, and non-moving gear ratios (i.e., park or neutral). Lastly, the axle assembly 13 is also conventional in the art and may, for example, be embodied as a differential mechanism. However, the axle assembly 13 may be embodied as any desired structure that transmits the mechanical rotational power from the transmission 12 to the wheels of the vehicle.

The vehicle drive train assembly 10 operates a pump drive unit 20. The pump drive unit 20 provides rotational power from the vehicle drive train assembly to a device (see below) that delivers pressurized fluid to a hydraulic system 30. The structure and operation of the pump drive unit 20 will be described in detail below. In one embodiment of this invention, the hydraulic system 30 delivers pressurized fluid to a single hydraulically actuated device, such as a snow plow, auger/spreader, aerial bucket, and the like. In another embodiment of this invention, the hydraulic system 30 delivers pressurized fluid to a plurality of such hydraulically actuated devices. In still another embodiment of this invention, the hydraulic system 30 delivers pressurized fluid to a single hydraulically actuated device with only intermittent use of the pump drive unit 20. The various embodiments of the hydraulic system 30 may preferably be used independent of whether the vehicle is moving or stationary.

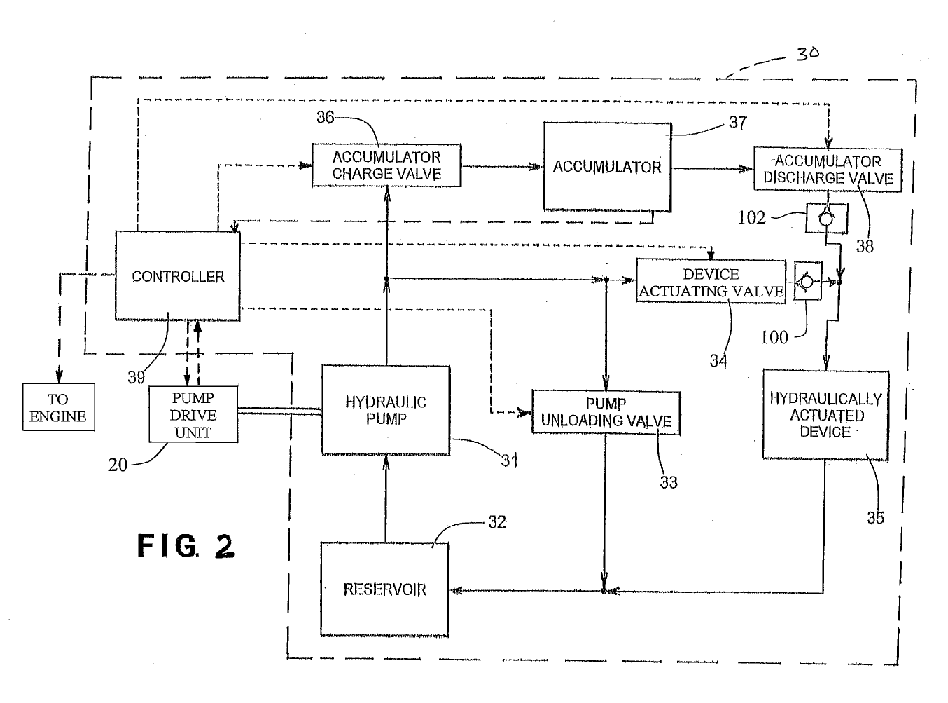

Referring now to FIG. 2, the structure of the hydraulic system 30 is illustrated in detail. As shown therein, the hydraulic system 30 includes a hydraulic pump 31 that operates in a conventional manner to generate a flow of pressurized hydraulic fluid. The pump drive unit 20 is coupled to the hydraulic pump 31 and functions as the rotational power source to generate fluid pressure and flow, as will be described in detail below. The hydraulic pump 31 may be embodied as any desired structure that is responsive to rotational inputs of the pump drive unit 20 for drawing hydraulic fluid from a reservoir 32 into an inlet port thereof and for generating a flow of hydraulic fluid through an output port thereof. The inlet port of the hydraulic pump 31 is connected to the reservoir 32, which serves as a source of hydraulic fluid. The reservoir 32 typically maintains hydraulic fluid at a lower pressure than the rest of the hydraulic system 30.

The output port of the hydraulic pump 31 is connected through a pump unloading valve 33 to the reservoir 32. The pump unloading valve 33 is conventional in the art and is operable in either an opened condition, wherein fluid communication from the hydraulic pump 31 to the reservoir 32 is permitted, and a closed condition, wherein fluid communication from the hydraulic pump 31 to the reservoir 32 is prevented. Preferably, the pump unloading valve 33 is a solenoid-operated fluid valve. However, the pump unloading valve 33 may be embodied as any desired fluid valve structure.

The output port of the hydraulic pump 31 is also connected through a device actuating valve 34 and a first check valve 100 to a hydraulically actuated device 35. The device actuating valve 34 is conventional in the art and is operable in either an opened condition, wherein fluid communication from the hydraulic pump 31 to the hydraulically actuated device 35 is permitted, and a closed condition, wherein fluid communication from the hydraulic pump 31 to the hydraulically actuated device 35 is prevented. Preferably, the device actuating valve 34 is a solenoid-operated fluid valve. However, the device actuating valve 34 may be embodied as any desired fluid valve structure. The first check valve 100 is also conventional in the art and is operable to permit the one-way flow of fluid from the device actuating valve 34 to the hydraulically actuated device 35. The purpose for the first check valve 100 will be explained below.

The illustrated hydraulically actuated device 35 is intended to be representative of any mechanism or group of mechanisms that is responsive to the flow of hydraulic fluid from the output port of the hydraulic pump 31 for performing a function. For example, the hydraulically actuated device 35 may be a device that is responsive to the flow of hydraulic fluid from the hydraulic pump 31 for performing snow plowing, aerial bucket movement, or other functions. If desired, the hydraulically actuated device 35 can be a double-acting mechanism such as, for example, a hydraulically actuated linear actuator having a piston that can reciprocate in two directions relative to a cylinder. Additionally, the hydraulically actuated device may be a hydraulic motor having a rotational output that may be driven in one direction and, alternatively, in a reverse direction. In such instances, a plurality of valves (not shown) may be provided for actuating the hydraulically actuated device 35, as is well known in the art. As will be explained in detail below, during normal operation of the vehicular drive train system 10, the pump drive unit 20 drives the hydraulic pump 31 to generate a flow of pressurized hydraulic fluid to the hydraulically actuated device 35, causing the same to be operated. The hydraulic fluid then flows from the hydraulically actuated device 35 back to the reservoir 32.

The output port of the hydraulic pump 31 is further connected through an accumulator charge valve 36 to a hydraulic accumulator 37. The accumulator charge valve 36 is conventional in the art and is operable in either an opened condition, wherein fluid communication from the hydraulic pump 31 to the accumulator 37 is permitted, and a closed condition, wherein fluid communication from the hydraulic pump 31 to the accumulator 37 is prevented. Preferably, the accumulator charge valve 36 is a solenoid-operated fluid valve. However, the accumulator charge valve 36 may be embodied as any desired fluid valve structure.

The accumulator 37 is conventional in the art and is adapted to store fluid under pressure. To accomplish this, the accumulator 37 may be a vessel in which a quantity of essentially non-compressible hydraulic fluid is held under pressure by an external source, such as a spring or a compressed gas. However, the accumulator 37 may be embodied as any desired structure for storing a quantity of pressurized hydraulic fluid from the hydraulic pump 31. The purpose for the accumulator 37 will be explained in detail below.

The accumulator 37 is connected through an accumulator discharge valve 38 and a second check valve 102 to the hydraulically actuated device 35. The accumulator discharge valve 38 is conventional in the art and is operable in either an opened condition, wherein fluid communication from the accumulator 37 to the hydraulically actuated device 35 is permitted, and a closed condition, wherein fluid communication from the accumulator 37 to the hydraulically actuated device 35 is prevented. Preferably, the accumulator discharge valve 38 is a solenoid-operated fluid valve. However, the accumulator discharge valve 38 may be embodied as any desired fluid valve structure. The second check valve 102 is also conventional in the art and is operable to permit the one-way flow of fluid from the accumulator discharge valve 38 to the hydraulically actuated device 35. The purpose for the second check valve 102 will be explained below.

As mentioned above, the pump unloading valve 33, the device actuating valve 34, the accumulator charge valve 36, and the accumulator discharge valve 38 are each preferably embodied as solenoid-operated fluid valves. If desired, the pump unloading valve 33, the device actuating valve 34, the accumulator charge valve 36, the accumulator discharge valve 38, and the check valves 100 and 102 can all be provided within a single valve manifold block (not shown), the structure of which is conventional in the art.

Finally, the hydraulic system 30 includes a controller 39 that controls the operations of the pump unloading valve 33, the device actuating valve 34, the accumulator charge valve 36, and the accumulator discharge valve 38. The controller 39 is conventional in the art and may, for example, be embodied as any electronic control circuit, such as a microprocessor or a programmable controller. As will be explained in greater detail below, the controller 39 controls the operations of the pump unloading valve 33, the device actuating valve 34, the accumulator charge valve 36, and the accumulator discharge valve 38 to operate the hydraulic system 30 in accordance with this invention. The controller 39 is further illustrated to be in communication with the pump drive unit 20 to send and receive operational signals therebetween. The controller 39 may further be in communication with the engine 11 for a purpose that will be described in detail below.

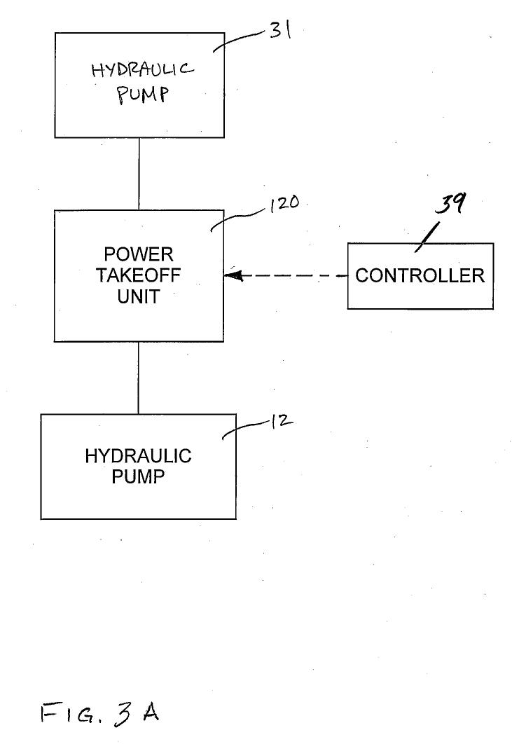

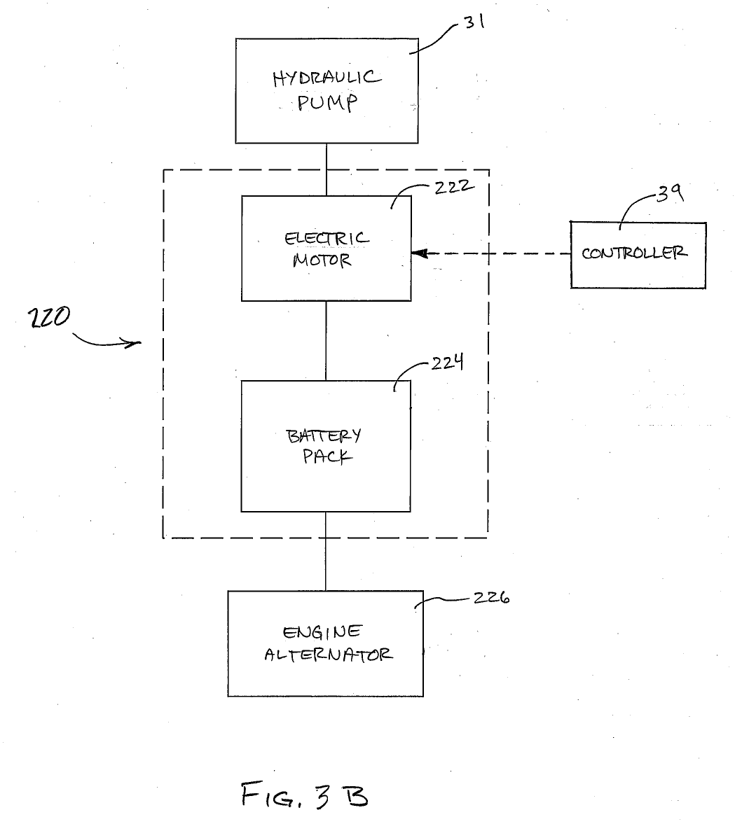

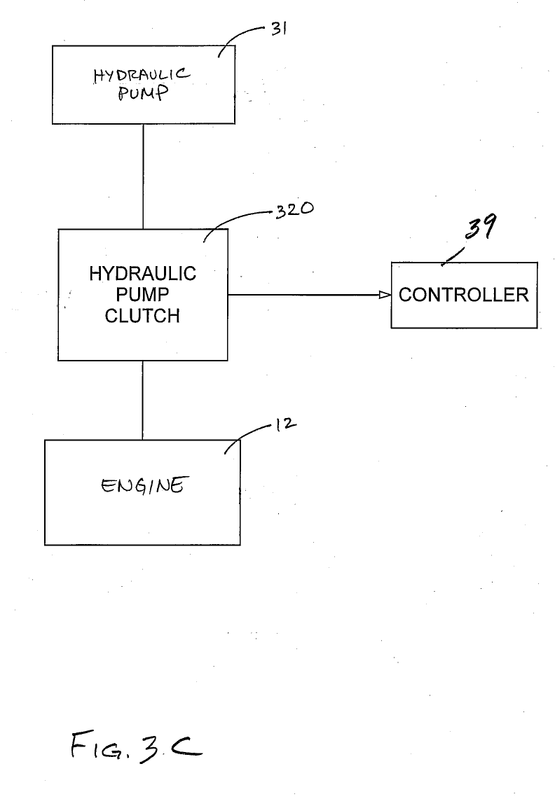

Referring now to FIG. 3A, a first embodiment of the pump drive unit 20 is illustrated as a power take off unit 120. The power take-off unit 120 is conventional in the art and may, for example, include a housing (not shown) that rotatably supports an input gear that can be rotatably driven by the transmission 12. The power take-off unit 120 also includes an output shaft and a set of intermediate gears that are connected in a gear train between the input gear and the output shaft so as to provide a rotatable driving connection therebetween. The set of intermediate gears may also permit one or more speed reduction gear ratios to be provided between the input gear and the output shaft, though such is not required. If desired, the power take-off unit 120 may include a clutch assembly for selectively disconnecting the output shaft from the input gear. However, the power take-off unit 120 may be embodied as any desired structure that is responsive to operation of the transmission 12 for causing rotation of the output shaft. The power take-off unit 120 may further include an actuating device, such as a solenoid, that is operated by the controller 39 to respond to operational commands generated therein.

Referring now to FIG. 3B, a second embodiment of the pump drive unit 20 is illustrated as an electric pumping unit 220. The electric pumping unit 220 may include an electric motor 222 and battery pack 224. The battery pack 224 supplies electrical power to the electric motor 222 and may include any type of electrical power storage device. The electric motor 222 operates the hydraulic pump 31 to provide a source of pressurized hydraulic fluid to the hydraulic system 30, as shown in FIG. 2. The battery pack 224 is also electrically connected to the engine 11 and, preferably, to an alternator 226 that is part of the engine 11, to recharge the battery pack 2224 as needed. The alternator 226 may be embodied any device to provide a source of electrical power to maintain an adequate battery charge state such as, for example, a stand-alone, engine-driven generator system. The electric motor 222 drives the hydraulic pump 31 to pressurize the hydraulic fluid in a conventional manner. The electric motor 222 is preferably operated by the controller 39 to respond to operational commands generated therein.

Referring now to FIG. 3C, a third embodiment of the pump drive unit 20 is illustrated as a hydraulic pump clutch 320 that is mechanically coupled to the engine 11. The hydraulic pump clutch 320 is conventional in the art and includes a clutching mechanism to mechanically couple and decouple the hydraulic pump 31 from the source of rotational power. The hydraulic pump clutch 320 may be embodied as any clutch device, whether mechanically or electrically actuated. Preferably, however, the hydraulic pump clutch 320 is an electromagnetically actuated clutch that is conventional in the art. The pump clutch 320 is preferably operated by the controller 39 to respond to operational commands generated therein. The pump clutch 320 may be coupled to the engine 11 by means of a drive belt that is conventional in the art. Alternatively, the pump clutch 320 may be coupled directly to the crankshaft of the engine 11 if desired.

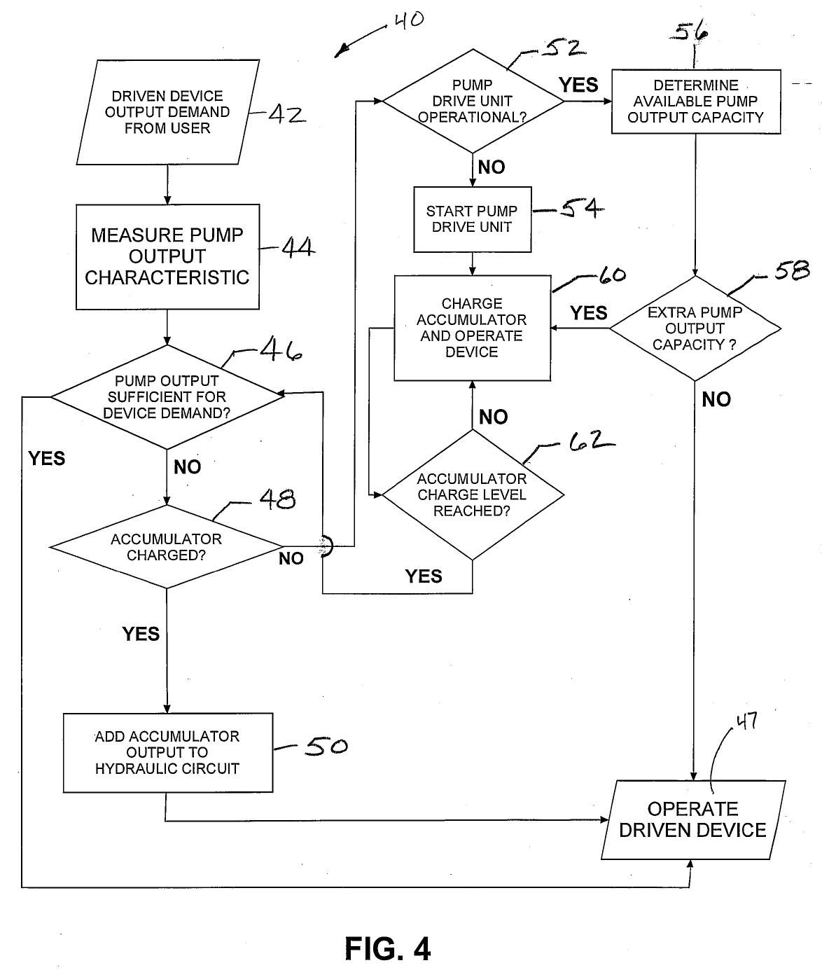

Referring now to FIG. 4, there is illustrated a flowchart of a method, indicated generally at 40, for operating the hydraulic system 30 illustrated in FIGS. 1 and 2 in accordance with this invention. In a first step 42 of the method 40, the user initiates operation of the hydraulically actuated device 35. In a second step 44, the controller 39 measures an operating characteristic of the pump 31. The pump operating characteristic is indicative of the operational state of the hydraulic pump 39 and may indicate an on/off state or a pump output state such as, for example, the percentage of pump output in use relative to the total pump capacity. In the first embodiment of the pump drive unit 20, the pump operating characteristic may include, for example, a gear speed measurement of the power take-off unit 120. In the second embodiment of the pump drive unit 20, the pump operating characteristic may include, for example, the rotational speed or current draw of the electric motor 222. In the third embodiment the pump operating characteristic may include, for example, the engaged or disengaged state of the pump clutch 320. It should be understood that any signal that is indicative of the pump output state may be a suitable input to the controller 39.

In a first decision point 46 of the method 40, the measured pump output characteristic is compared with to the operating requirements of the hydraulically actuated device 35, such as for example fluid flow rate or pressure. The comparison can be performed in any desired manner by the controller 39. The controller 39 can determine if the pump output is sufficient to satisfy the device demand. If the controller 39 determines that the pump capacity will meet the fluid input requirements of the device 35, then the method 40 branches to an instruction 47, wherein the hydraulically actuated device 45 is operated. To accomplish this, the controller 39 can send a signal to the device actuating valve 34, causing it to open and thus admit fluid flow to operate the hydraulically actuated device 35. The controller 39 can also send a signal to the pump unloading valve 33 and the accumulator charge valve 36, causing them to remain in or return to a closed state, thus preventing fluid flow therethrough.

If, on the other hand, it is determined at the decision block 46 that the pump output is not sufficient to satisfy the device demand, then the method 40 branches to a decision block 48, wherein it is determined whether the hydraulic accumulator 37 is charged. The charge state of the accumulator 37 is related to the volume of stored hydraulic fluid contained therein. An adequate charge state of the accumulator 37 may be equated to a predetermined threshold characteristic such as, for example, a threshold pressure or fluid volume, below which would trigger an accumulator charge cycle, as will be explained below. The charge state of the accumulator 37 may also be determined to be in a fully charged condition indicating no more fluid can be admitted thereto. However, the charge state of the accumulator 37 may be determined in any manner or by any method desired. The controller 39 may measure the charge state of the accumulator 37, for example, by way of a conventional pressure sensor (not shown).

If it is determined that the charge state of the accumulator 37 is above the threshold pressure, the method 40 branches to an instruction 50, wherein the output from the accumulator 37 is added to the hydraulic system 30. To accomplish this, the controller 39 can send a signal to the accumulator discharge valve 38 causing it to open and, thus, admit fluid flow through the check valve 102 to the hydraulically actuated device 35. The accumulator discharge valve 38 may operate as a proportional valve to admit a fluid flow sufficient to operate the device 35 to the desired performance level without generating an excessive amount of such hydraulic fluid thereto. However, the input fluid flow to the device 35 may be controlled in any manner desired, such as for example by regulating the fluid flow through opening of the pump unloading valve 33. The pump unloading valve 33 may also be a proportional valve having a flow rate adjustment capability if desired.

If, on the other hand, it is determined in the decision point 48 that the charge state of the accumulator 37 is not above the threshold pressure, then the method 40 branches to a decision point 52, wherein it is determined whether the pump drive unit 20 is operational. The operational state of the various embodiments of the pump drive unit 20 shown in FIGS. 3A, 3B, and 3C may be determined as described above. However, the operational state of the hydraulic pump 31 may be determined directly such as through measurement of the pump fluid output or input characteristics, if desired. If the pump drive unit 20 or the hydraulic pump 31 is determined to be not operational, then the method 40 branches from the decision point 52 to an instruction 54, wherein the operation of the pump drive unit 20 is started. This can be accomplished by the controller 39 in a conventional manner. If, on the other hand, it is determined in the decision point 52 that the pump drive unit 20 is operational, then the method 40 branches from the decision point 52 to an instruction 56, wherein it is determined what portion of the pump output capacity remains available. The available pump output capacity indicates what remainder of pump fluid output, not already in use, is available to operate one or more hydraulically actuated devices 35. The available pump capacity may simply be determined as the difference between the total pump flow capacity, less the flow requirements of the hydraulically actuated device or devices 35. However, the available pump capacity may be determined in any manner and may include other pump operational factors, if desired.

Once the available output of fluid flow available to the hydraulic circuit 30 is known, the method 40 enters a decision point 58, wherein it is determined if an excess output capacity of the hydraulic pump 31 exists that is sufficient to initiate the accumulator charge operation. If the hydraulic pump capacity is not sufficient to charge the accumulator 37, then the method 40 branches from the decision point 58 to the instruction 47, wherein the hydraulically actuated device 35 is operated as described above with the remaining output capacity of the hydraulic pump 31. If, on the other hand, it is determined at the decision point 58 that the hydraulic pump capacity is sufficient to charge the accumulator 37, then the method 40 branches from the decision point 58 to an instruction 60, wherein the accumulator 37 is charged and the hydraulically actuated device 35 is operated. Alternatively, the instruction 60 can be reached by the method 40 following the instruction 54 or decision block 58. In either event, the instruction 60 contemplates both the operation of any hydraulically actuated devices 35 that are currently operating and the fluid charging of the accumulator 37. The controller 39 can initiate the accumulator charge operation by sending appropriate signals to open the accumulator charge valve 36, thus admitting fluid flow into the accumulator 37, and to close (or keep closed) the accumulator discharge valve 38, thus preventing fluid flow out from the accumulator 37.

The method 40 thereafter enters a decision point 62, wherein it is determined if the desired accumulator charge state has been reached. The controller 39 monitors the charge state of the accumulator 37, as described above, until a fully charge condition is indicated. Alternatively, the controller 39 may be programmed to allow for a partially charged state of the accumulator 37 to exist when ceasing the charging cycle. Once the desired accumulator charge level is reached, the controller 39 sends appropriate signals to the accumulator charge valve 36 to close, thus preventing further fluid admittance into the accumulator 37.

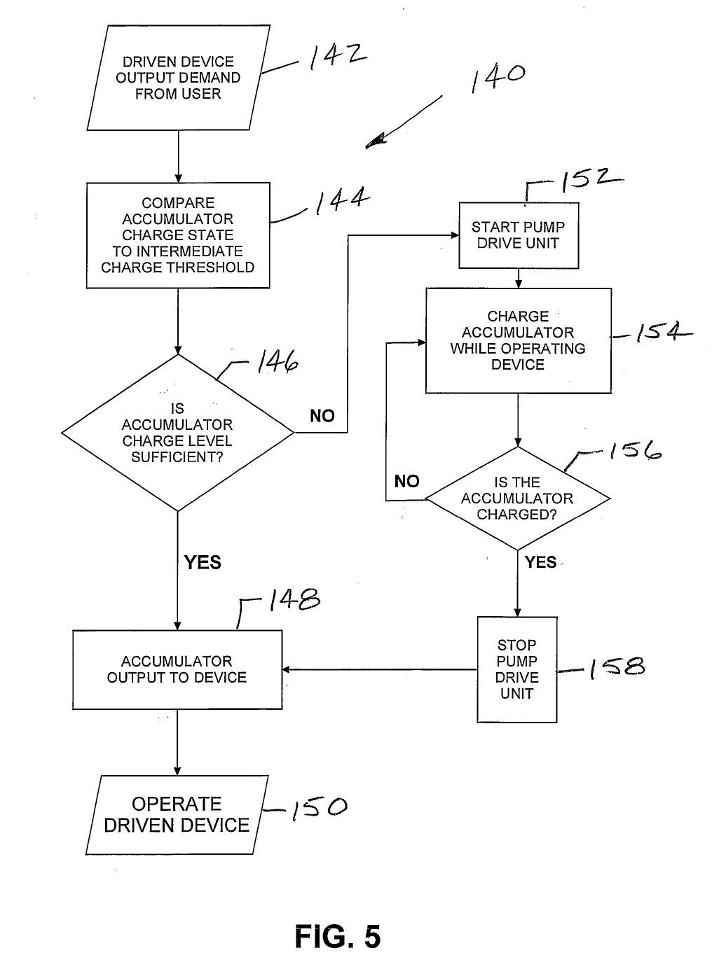

Referring now to FIG. 5, there is illustrated a flowchart of a method of operation, indicated generally at 140, of the hydraulic system 30 illustrated in FIGS. 1 and 2 in accordance with another embodiment of the invention. The method 140 may be utilized in any suitable hydraulic device application, but may preferably used in conjunction with an aerial lift or aerial bucket application, which is conventional in the art. The method 140 of FIG. 5 preferably utilizes the accumulator 37 as the primary fluid power source to operate the hydraulically actuated device 35, though such is not required. The hydraulic pump 31, driven by any of the various embodiments of the pump drive unit 20 described above, provides fluid flow to charge the accumulator 37 during operation of the hydraulic system 30. The controller 39, as shown in FIG. 2, is in communication with the various embodiments of the pump drive unit 20 in order to initiate fluid output from the hydraulic pump 31 as will be described below. Additionally, the controller 39 may also be in communication with one or more components of the drive train 10, and preferably with the engine 11. The engine 11 may be started to operate the various embodiments of the pump drive unit 20 such as, for example, the power take-off unit 120 shown in FIG. 3A, or an electrical charging source such as the engine alternator 226 shown in FIG. 3B.

The method 140 begins with the accumulator 37 in a substantially full fluid charge state, though such is not required. In a first operation block 142, a user demand is made of the hydraulically actuated device 35. Next, in a second operation block 144, the controller 39 measures the accumulator charge state, as described above, and compares this measurement to an intermediate charge threshold value. The value of the intermediate charge threshold may be, for example, a pressure level of the accumulator 39 that is between the fully charged state and the threshold charge value, as described above. However, the intermediate charge threshold may be any value less than the fully charged state value, including an empty fluid state or the predetermined threshold pressure described above. The intermediate charge threshold may trigger a recharging of the accumulator 37 by the hydraulic pump 31 where a residual pressure state and/or a residual fluid volume may be contained therein. The remaining charge state of the accumulator 37 may also be an amount that is sufficient to operate the hydraulically actuated device 35 for a predefined period of time, though such is not required.

After comparing the measured charge state of the accumulator 37, the controller 39 proceeds to a decision block 146 to determine if the charge state of the accumulator 37 is greater than the intermediate charge threshold. If the charge state of the accumulator 37 is above the intermediate charge threshold, the controller proceeds to operation block 148. In operation block 148, the controller 39 sends a signal to the pump unloading valve 33 and the accumulator charge valve 36, shown in FIG. 2, to close or maintain a closed state, thus preventing fluid flow therefrom. The device actuating valve 34, shown in FIG. 2, may be maintained in a closed state or alternatively may be omitted from the hydraulic system 30 along with the illustrated connections, if desired. The controller 39 sends a signal to the accumulator discharge valve 36 to open, thus admitting fluid flow the hydraulically actuated device 35, as shown in FIG. 2. The flow of fluid may pass from the accumulator discharge valve 38 through the check valve 102, as shown in FIG. 2, though such is not required. The hydraulically actuated device 35 is powered for operation in step 150.

If the controller 39 determines, at decision block 146, that the charge level of the accumulator 37 is below the intermediate charge threshold value, the control logic proceeds to operation block 152 to start the pump drive unit 20. The pump drive unit 20 is operated in conjunction with the various embodiments illustrated in FIGS. 3A-3C. In the first embodiment of the pump drive unit 20, the power take-off unit 120 may be actuated from a disengaged state with the transmission 12 to an engaged state therewith by a solenoid actuator or other device that is known in the art. Additionally, the controller 39 may send a signal to remotely start the engine 11, if not currently in a running state. The electric motor 222 of the electric pumping unit 220 of the second embodiment may be started by a switch (not shown) which is energized by an appropriate signal from the controller 39, if desired. The hydraulic pump clutch 320 of the third embodiment pump drive unit may be energized or mechanically actuated to an engaged position, as described above.

After the pump drive unit 20 is started, the controller 39 sends a signal to the accumulator charge valve 36 to open, thus admitting fluid into the accumulator 37. The accumulator charge valve 36 may be directly connected to the accumulator 37 as shown in FIG. 2. Alternatively, another of the check valves 100 or 102 may be disposed between the accumulator charge valve 36 and the accumulator 37 to provide a one-way flow of fluid into the accumulator from the hydraulic pump 31, if desired. In a preferred embodiment of the method 140, the hydraulically actuated device 35 continues to operate while the accumulator 37 is charging. During the charging operation, the controller 39 monitors the charge level of the accumulator 37 to determine if charging should continue, as shown in a decision block 156. If the controller 39 determines that the accumulator 37 has reached a fully charged or predetermined charge level threshold, the method 140 advances to operation block 158 where the various embodiments of the pump drive unit 20 are switched to an off, idle, or otherwise inoperative state. The controller 39 continues to maintain flow of fluid from the accumulator 37 to the hydraulically actuated device 35 as long as there is a device demand from the user.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A system for operating a hydraulically actuated device that is provided on a drive train system comprising:
a pump drive unit that is adapted to be driven by a drive train system;
a hydraulic pump that is driven by the pump drive unit;
an accumulator;
a hydraulically actuated device; and
a controller that causes the hydraulic pump to supply pressurized fluid within the system when a demand is made by the hydraulically actuated device, the controller further causing the accumulator to supply pressurized fluid within the system when the supply of pressurized fluid from the hydraulic pump is insufficient to meet the demand.

2. The system of claim 1 wherein the drive train includes a transmission and the pump drive unit is a power take-off unit that engages the transmission.

3. The system of claim 1 wherein the pump drive unit is an electric motor connected to an electric power storage device and the drive train includes an engine that drives a source of electrical power to maintain an adequate charge within the electrical storage device.

4. The system of claim 1 wherein the drive train includes an engine and the pump drive unit is a pump clutch driven by the engine.

5. The system of claim 1 wherein the controller causes the hydraulic pump to supply pressurized fluid within the system to the hydraulically actuated device initially and the controller further causing the hydraulic pump to supply pressurized fluid to the accumulator when a threshold pressure is reached.

6. The system of claim 1 wherein the controller causes the accumulator to supply pressurized fluid within the system to the hydraulically actuated device initially and the controller further causing the hydraulic pump to supply pressurized fluid to the accumulator.

7. The system of claim 2 wherein the drive train includes an engine connected to the transmission and the controller causes the transmission to drive the power takeoff unit to supply pressurized fluid to the hydraulically actuated device.

8. The system of claim 3 wherein the source of electric power is an alternator driven by the engine and the engine is connected to a transmission.

9. The system of claim 3 wherein the engine and the source of electrical power are a stand-alone engine-driven generator system.

10. A system for operating a hydraulically actuated device that is provided on a drive train system comprising:
a pump drive unit that engages a portion of a drive train;
a hydraulic pump that is driven by the pump drive unit;
an accumulator;
a hydraulically actuated device; and
a controller that causes the hydraulic pump to supply pressurized fluid to the hydraulically actuated device when a demand is made by the hydraulically actuated device, the controller further causing the accumulator to supply pressurized fluid to the hydraulically actuated device when the supply of pressurized fluid from the hydraulic pump is insufficient to meet the demand.

11. The system of claim 10 wherein the controller is in communication with a device actuating valve, the controller adapted to respond to the demand by sending a signal to the device actuating valve to open thereby selectively allowing fluid communication between the hydraulic pump and the hydraulically actuated device.

12. The system of claim 10 the controller is in communication with an accumulator discharge valve, the controller adapted to respond to the demand by sending a signal to the accumulator discharge valve to open thereby selectively allowing fluid communication between the accumulator and the hydraulically actuated device.

13. The system of claim 10 wherein the controller is in communication with an accumulator charge valve, the controller adapted to respond to an accumulator charge state, the controller adapted to send a signal to the accumulator charge valve to open thereby selectively allowing fluid communication between the accumulator and the hydraulic pump.

14. The system of claim 10 wherein the system includes a reservoir in fluid communication with the hydraulic pump and a pump unloading valve and the controller is in communication with the pump unloading valve, the controller being responsive to the demand by sending a signal to the pump unloading valve to open such that a portion of the flow of pressurized fluid is diverted to the reservoir in order to modulate the flow of fluid to the hydraulically actuated device.

15. The system of claim 10 wherein a first check valve is in fluid communication with the accumulator and the hydraulically actuated device and a second check valve is in fluid communication with the hydraulic pump and the hydraulically actuated device.

16. The system of claim 15 wherein the hydraulically actuated device is a plurality of hydraulically actuated devices and the controller is in communication with an accumulator discharge valve and a device actuating valve, the controller adapted to respond to the demand from the plurality of hydraulically actuated devices by sending a signal to the accumulator discharge valve and the device actuating valve to open causing fluid to flow to the plurality of hydraulically actuated devices.

17. The system of claim 10 wherein the pump drive unit is one of a power takeoff, an electric pumping unit, and an engine-driven pump clutch.

18. A combined vehicular drive train assembly for a vehicle and system for operating a hydraulically actuated device that is provided on a vehicle comprising:
a vehicular drive train system including an engine, a transmission, and an axle assembly;
a pump drive unit supported on the vehicle;
a hydraulic pump that is driven by the pump drive unit;
an accumulator;
a hydraulically actuated device; and
a controller that causes the hydraulic pump to supply pressurized fluid within the system when a demand is made by the hydraulically actuated device, the controller further causing the accumulator to supply pressurized fluid within the system when the supply of pressurized fluid from the hydraulic pump is insufficient to meet the demand.

19. The combined vehicular drive train assembly and hydraulic operating system of claim 18 wherein the pump drive unit engages the vehicular drive train.

20. The combined vehicular assembly and hydraulic operating system of claim 18 wherein the pump drive unit engages an engine that is adapted to be supported on the vehicle and not connected to the vehicular drive train.
